(19) United States
(12) Patent Application Publication
(10) Pub. No.: US 2006/0097021 A1
(43) Pub. Date: May 11, 2006

(54) Auto trunk organizer

(76) Inventor: Richard L. Stanton, Shrewsbury, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/983,837

(22) Filed: Nov. 8, 2004

(51) Int. Cl. B60R 11/00; B60R 9/00

(52) U.S. Cl. 224/510; 224/404

(57) ABSTRACT

The present invention provides an auto trunk organizer having two layers of storage including a sliding tray which allows easy access to the stored material. When the organizer is in closed mode, none of the stored materials are visible within the auto. When the organizer is deployed substantially all of the stored materials are visible.

### CROSS REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

The present invention relates to an Auto Trunk Organizer. Quite simply the present invention provides an apparatus which can be inserted into the trunk space of an auto and provide organization of many items needed to be kept in the trunk of an auto.

For example, a pharmaceutical detail person is a person who visits doctors and pharmacies with samples of new medications and provides the physician or pharmacist with valuable information concerning products being placed in the market place. The detail person is required to carry a large number of samples of many different drugs and pharmaceutical products concealed in the trunk of an auto.

There have been many attempts to provide automobile trunk storage units. For instance, U.S. Pat. No. 5,469,999 to George Phirippidis, Nov. 28, 1995 wherein modular units are set into the trunk of the auto and each can be removed in order to restrain items from moving around in the trunk space. These multiple box-shaped units do not adapt well to the general design of the interior of the auto trunk.

The present invention provides an auto trunk organizer which enables the user to utilize substantially all of the auto trunk space and have access to the product stored in the organizer and in surrounding areas.

### BRIEF SUMMARY OF THE INVENTION

The present invention provides an auto trunk organizer comprising (a) a base unit generally rectangular in shape having two sidewalls and a rear wall. The base is adapted to reside on the floor of the auto trunk. The auto trunk organizer also comprises (b) a substantially U-shaped intermediate sliding unit, slidably connected to an upper portion of the two sidewalls of the base unit. In addition, the auto trunk organizer has (c) a sliding tray slidably connected to the interior of the sides of the U-shaped unit. The tray has a back portion, parallel sides connected to the back portion and a bottom portion cooperating with the tray back and sides to form a slidable tray capable of sliding sufficiently forward past the front of the U-shaped intermediate sliding unit and through the auto trunk opening so that most of the tray projects beyond a lower wall of the trunk opening. When the sliding tray is moved forward projecting through the auto trunk opening, the storage space within the confines of the organizer base unit is visible and available for storage of product or any other objects. As a result the auto trunk organizer of the present invention has two levels which provide storage, the lower level being the floor of the trunk within the confines of the base unit and on either side of the base unit, and the sliding tray which resides above the base unit when the unit is in a closed position.

The substantially U-shaped sliding unit enables the sliding tray to project sufficiently far through the auto trunk opening so that substantially all of the sliding tray extends beyond the opening of the trunk. This enables a large portion of the sliding tray to be immediately available for insertion or removal of objects thereby enhancing the storage capabilities of the auto trunk. Furthermore, the floor of the auto trunk is available for storage of items within the confines of the base unit and on either side of the base unit whether the sliding tray is in a closed or open position.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a perspective view of one embodiment of an auto trunk organizer of the present invention;

FIG. 2 is a perspective view of the embodiment of FIG. 1 wherein the auto trunk organizer is disposed in a stored position in an auto trunk;

FIG. 3 is a front elevational view of the embodiment of FIG. 2;

FIG. 4 is a top plan view of FIG. 2;

FIG. 5 is a side elevational view of the embodiment of FIG. 2;

FIG. 6 is an exploded sectional front elevational view within the circle 6-6 of FIG. 3;

FIG. 7 is a top plan view of the embodiment of FIG. 1; and

FIG. 8 is a side elevational view of FIG. 7.

Corresponding reference characters indicate corresponding parts throughout the several views of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what is presently believed to be the best mode of carrying out the invention. As various changes could be made in the above constructions without departing from the scope of the invention, it is intended that all matter contained in the above description or shown in the accompanying drawings shall be interpreted as illustrative and not in a limiting sense.

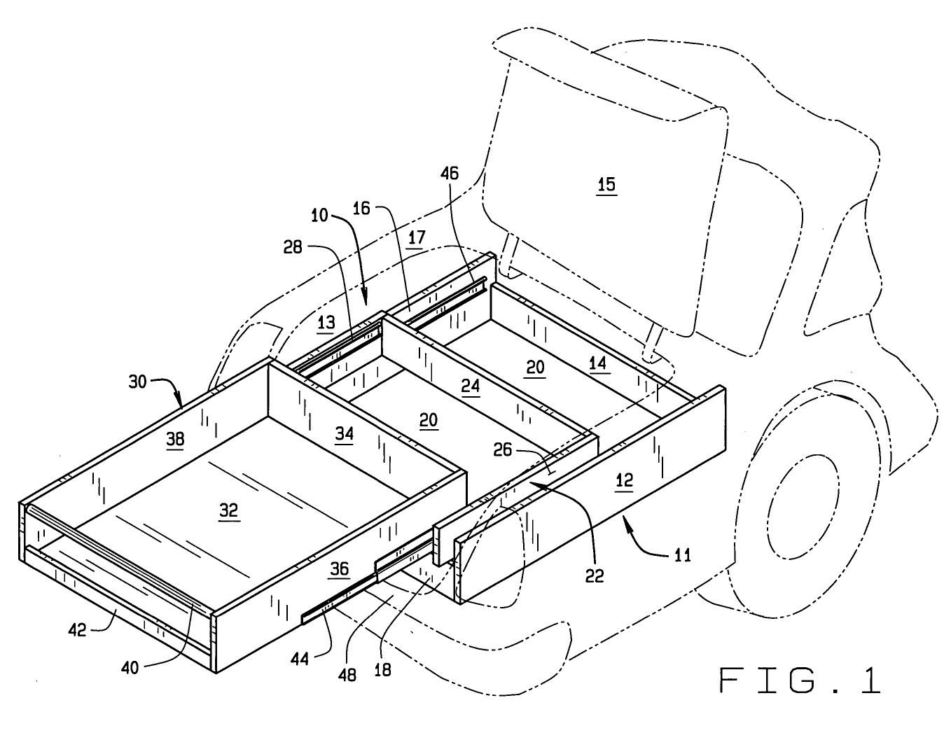

FIG. 1 is a perspective view depicting the auto trunk region of an auto 17 wherein the trunk lid 15 is open and an auto trunk organizer 10 of the present invention is shown in a deployed or open position.

The base 11 of the auto trunk organizer 10 has two sides 12 and 16, a rear wall 14 and (optionally) a front wall 18. Both the rear wall 14 and front wall 18 are of lesser height than the side walls 12 and 16. Affixed to the inside of the upper portion of the side walls 12 and 16 are a set of slide rails 46. The slide rails 46 allow a U-shaped intermediate unit 22 to slide toward the auto trunk opening. The U-shaped unit 22 has two side walls 26 and 28 and a rear wall 24. A double sliding track 44 is affixed to the interior of the sidewalls 26 and 28 of the intermediate U-shaped unit 22 to accommodate a sliding tray 30. The sliding tray 30 has two sidewalls 36 and 38, a rear wall 34 and a shelf or bottom 32. The shelf 32 may be removable or may be fixed in place. Preferably the sliding tray 30 has a lip 42 to prevent items from sliding out of the tray unit 30 when the auto is in motion or the tray 30 is deployed to the open position.

The auto trunk floor 20 is visible from above within the base unit 11 and the intermediate unit 22 when the intermediate unit 22 is at least partially deployed. Items may be stored on the floor 20 of the trunk so long as any items on the floor 20 within the confines of the base unit 11 are not sufficiently tall to interfere with the sliding movement of the intermediate unit 22. In addition, it is desirable to have a pull bar 40 for ease of operating the sliding tray 30 for deployment in the open position as shown in FIG. 1. On either side of the auto organizer unit 10 there is a space 13 in which additional items or product may be placed.

On the interior of each of the intermediate unit 22 walls 26 and 28 there is a double slide rail 44 which allows the drawer 30 to extend fully in a forward position, extending out of the auto trunk wherein the rear wall 34 is almost even with the lower wall 48 of the auto trunk at the rear of the auto.

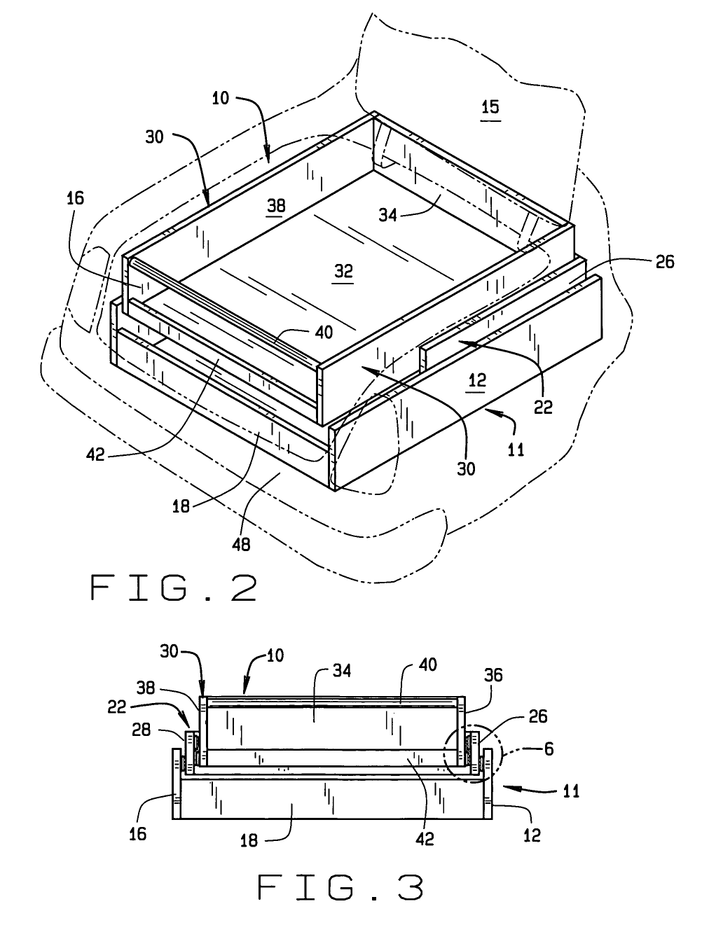

FIG. 2 is a perspective view of the auto trunk organizer 10 displayed in a closed position within the auto 17. The relationship of the base unit 11 to the intermediate U-shaped unit 22 and the tray unit 30 become very clear. The auto trunk organizer 10 provides two layers of storage area, both of which are fully accessible without moving any items or product within the space 13 in the auto trunk.

FIG. 3 is a front elevational view of the embodiment of FIG. 2 depicting the base 11, the intermediate U-shaped unit 22, and the sliding tray 30.

FIG. 4 depicts the auto trunk organizer 10 of FIG. 2 from a top view. The organizer 10 is in a closed position as it would be in storage when the lid 15 of the auto trunk is closed. Beneath the intermediate sliding unit 22 is a reinforcing bar 29 placed across the open end of the U-shaped unit connecting the lower portion of the sidewall 26 and the lower portion of the sidewall 28. The reinforcing bar 29 merely keeps the U-shaped unit 22 in its desired U-shape.

FIG. 5 is a right side elevational view of the auto trunk organizer 10 when in a stored position, showing the base unit side 12, the U-shaped unit side 26, and the tray unit side 36.

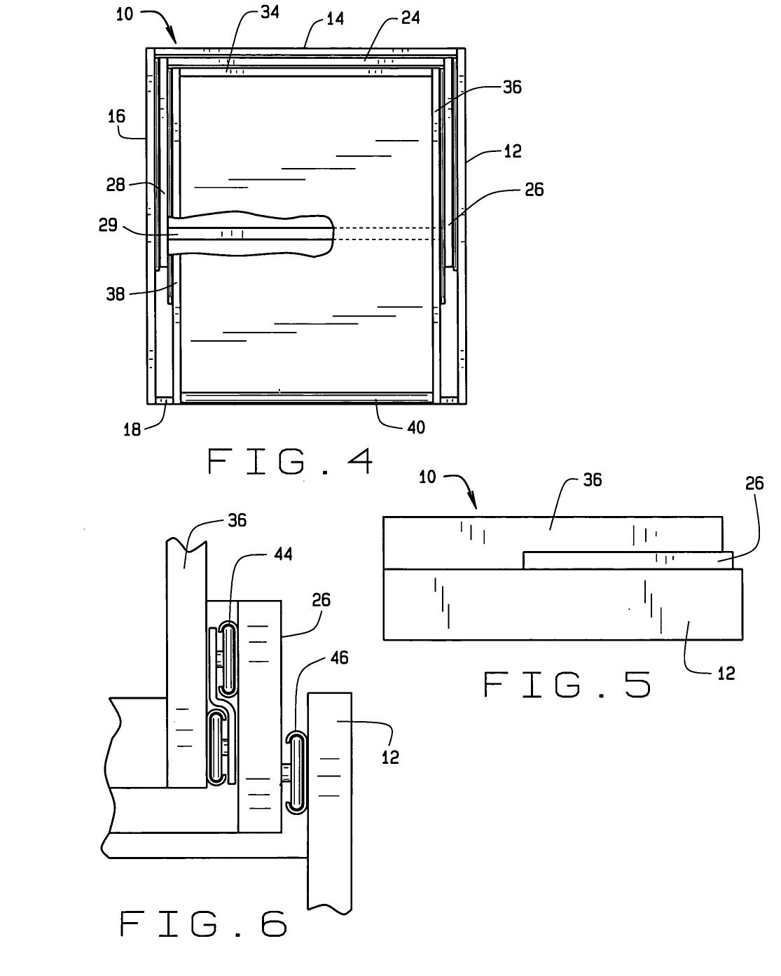

FIG. 6 is an exploded front view of the area of circle 6 in FIG. 3. FIG. 6 illustrates in detail the position of the sliding rails 44 and 46. A pair of sliding rails 46 are affixed to the interior of sides 12 and 16, respectively, of the base unit 11 (the side 12 is shown in FIG. 6) and to the exterior of sides 26 and 28 of the U-shaped unit 22 thereby allowing the U-shaped unit 22 (the side 26 is shown in FIG. 6) to slide toward the opening in the auto trunk. The pair of double sliding rails 44 are affixed to the interior of the side walls 26 and 28 of the U-shaped unit 22 (the side 26 is shown in FIG. 6) and to the exterior of the sides 36 and 38 of the sliding tray 30 (the side 36 is shown in FIG. 6). The double slide rails 44 allow the sliding tray 30 to project almost its entire length through the auto trunk opening as can be seen in FIG. 1.

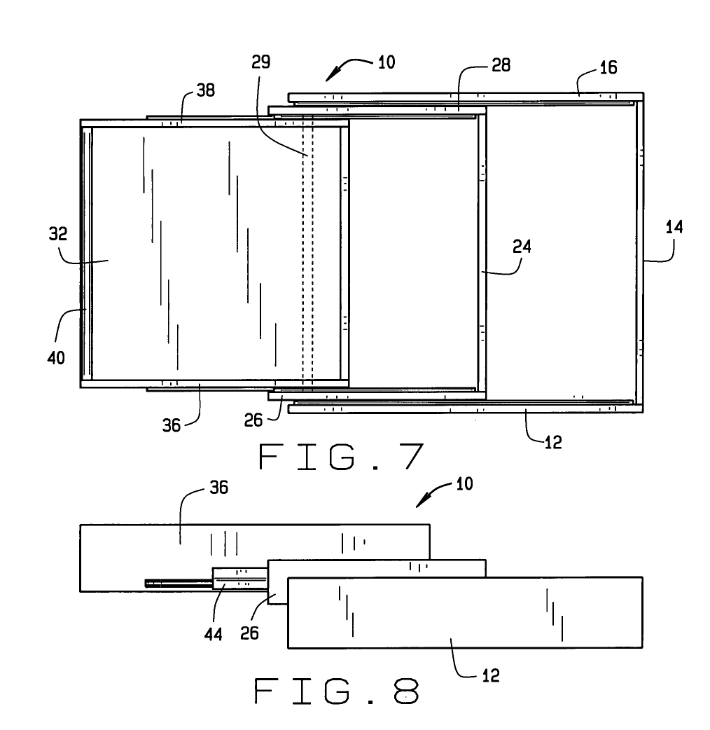

FIG. 7 is a top plan view of the auto trunk organizer 10 in the embodiment of FIG. 1 wherein the sliding tray 30 is deployed at least part way.

FIG. 8 is a right side elevational view of the auto trunk organizer 10 in the embodiment of FIG. 7.

The auto trunk organizer of the present invention provides storage for items in an auto trunk at two levels where when the sliding tray is deployed to the open position, all items stored in the auto trunk are visible and accessible. When the auto trunk organizer is in the closed or storage position all items are secure and none is visible when the trunk lid is closed. If it becomes necessary to remove the auto trunk organizer, e.g., in the event of a flat tire, preferably the sliding tray (containing stored items) is removable and then the remainder of the auto trunk organizer simply may be lifted from the trunk without having to move most of the stored items on the floor of the trunk. Thus the tire well, generally where the spare tire is stored, is available without having to disturb most of the stored items.

The auto trunk organizer of the present invention may be constructed of wood, metal, molded plastic, a combination of materials, or other suitable components. For instance, the shelf or bottom 32 of the drawer unit 30 may be of molded plastic or the like and removable, or it may be of a transparent material or wire mesh or other see through material whereupon when the organizer 10 is in closed mode, product on the bottom of the trunk may be seen through the bottom of the tray 30.

Having thus described the invention, what is claimed and desired to be secured by Letters Patent is:

1. An auto trunk organizer comprising:
(a) a base unit generally rectangular in shape having two side walls and a rear wall, the base being adapted to reside on the floor of the auto trunk;
(b) a substantially U-shaped intermediate sliding unit slidably connected to the interior of the side walls of the base; and
(c) a sliding tray slidably connected to the interior of the side walls of the U-shaped unit, the tray having a back portion, parallel sides connected to the back portion and a bottom portion affixed to cooperate with the tray back and sides to form a slidable tray capable of sliding sufficiently forward past the front of the U-shaped intermediate sliding unit through the auto trunk opening so that most of the tray projects beyond a lower wall of the trunk opening.

2. The auto trunk organizer of claim 1 wherein the side walls of the base are sufficiently higher than the rear wall to permit attachment of slide rails.

3. The auto trunk organizer of claim 1 wherein the base unit has a front wall lower in height than the side walls.

4. The auto trunk organizer of claim 1 wherein the U-shaped unit has a reinforcing bar across the open portion of the U connecting a lower portion of each of the U-shaped unit's side walls.

5. The auto trunk organizer of claim 1 wherein the sliding tray has a pull bar.

6. The auto trunk organizer of claim 1 wherein the bottom of the sliding tray is removable.

7. The auto trunk organizer of claim 1 wherein the bottom of the sliding tray is transparent or of wire mesh or of other see through material.
